(19) United States
(12) Patent Application Publication
(10) Pub. No.: US 2021/0345763 A1
(43) Pub. Date: Nov. 11, 2021

(54) Stowage Module And Cleaning Cloth Assembly

(71) Applicant: Evelyn Ramirez, Davie, FL (US)

(72) Inventor: Evelyn Ramirez, Davie, FL (US)

(21) Appl. No.: 16/870,194

(22) Filed: May 8, 2020

(51) Int. Cl. A45F 5/10; A47L 25/00

(52) U.S. Cl. CPC A45F 5/10; A45F 2200/0516; A45F 2005/1086; A47L 25/00

(57) ABSTRACT

A stowage module and cleaning cloth assembly for providing a readily accessible cleaning cloth includes a shell, a cloth, and a lid. The shell is mountable by a first face to at least one of an electronic device and a case that is engaged to the electronic device. The shell has a second face, which is open so that an interior space defined by the shell is accessible. The cloth can be used to clean a surface, such as a screen of the electronic device, and is selectively positionable in the interior space. The lid is selectively engageable to the shell to close the second face to retain the cloth in the shell. The lid can be disengaged from the shell by a user, positioning the user to access the cloth to clean the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stowage module and more particularly pertains to a new stowage module for providing a readily accessible cleaning cloth.

### (2) Description of Related Art Including Information Disclosed Under 37 CFR 1.97 and 1.98

The prior art relates to stowage modules. Prior art stowage modules for cleaning clothes may comprising a neck strap extending from an electronic device and having clamshell case engageable thereto, wherein a cleaning cloth is stowable in the clamshell case.

### BRIEF SUMMARY OF THE INVENTION

An embodiment of the disclosure meets the needs presented above by generally comprising a shell, a cloth, and a lid. The shell is configured to be mountable by a first face to at least one of an electronic device and a case that is engaged to the electronic device. The shell has a second face, which is open so that an interior space defined by the shell is accessible. The cloth is configured to clean a surface, such as a screen of the electronic device, and is selectively positionable in the interior space. The lid is selectively engageable to the shell to close the second face to retain the cloth in the shell. The lid is configured to be disengaged from the shell by a user, positioning the user to access the cloth to clean the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a stowage module and cleaning cloth assembly, in a compact configuration, according to an embodiment of the disclosure.

FIG. 2 is an isometric perspective view of a stowage module and cleaning cloth assembly, in an extended configuration, according to an embodiment of the disclosure.

FIG. 3 is an open isometric perspective view of an embodiment of the disclosure.

FIG. 4 is a side view of an embodiment of the disclosure.

FIG. 5 is a side view of an embodiment of the disclosure.

FIG. 6 is a cross-sectional view of an embodiment of the disclosure.

FIG. 7 is an in-use view of an embodiment of the disclosure.

### DETAILED DESCRIPTION OF THE INVENTION

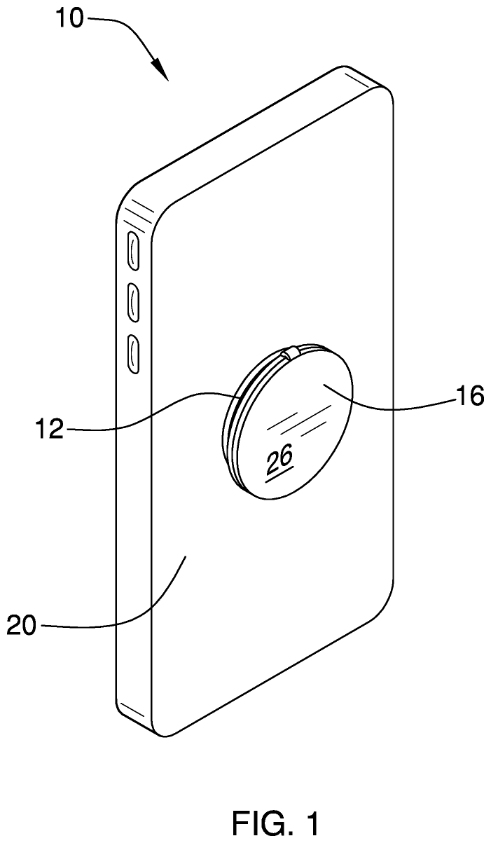

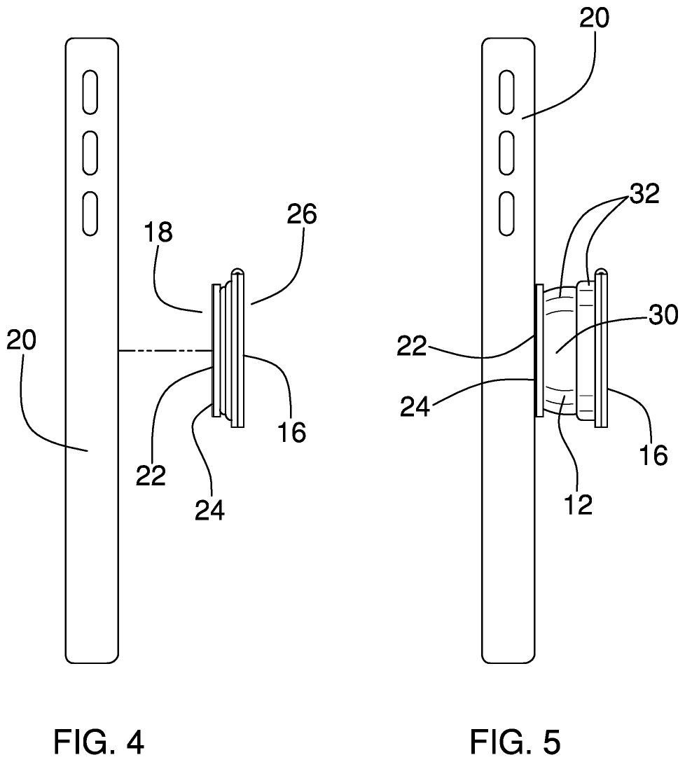

With reference now to the drawings, and in particular to FIGS. 1 through 7 thereof, a new stowage module embodying the principles and concepts of an embodiment of the disclosure and generally designated by the reference numeral 10 will be described.

As best illustrated in FIGS. 1 through 7, the stowage module and cleaning cloth assembly 10 generally comprises a shell 12, a cloth 14, and a lid 16. The shell 12 is configured to be mountable by a first face 18 to at least one of an electronic device and a case 20, which is engaged to the electronic device. The electronic device may include, for example, a smart phone, a tablet computer, and a smart watch.

A fastener 22 is engaged to the first face 18 of the shell 12 and is configured to engage the at least one of the electronic device and the case 20. The fastener 22 may comprise adhesive 24, or other fastening means for engaging the shell 12 to the at least one of the electronic device and the case 20, such as, but not limited to, hook and loop fasteners, clips, and the like. The present invention also anticipates the shell 12 being integral to the case 20. Additionally, the present invention anticipates the shell 12 being configured to be mountable to jewelry, such as, but not limited to lockets, bracelets, and the like.

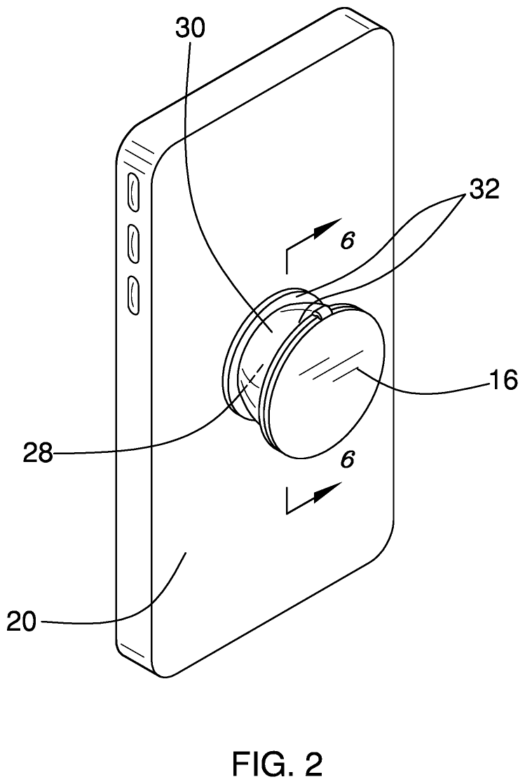

The shell 12 has a second face 26, which is open so that an interior space 28 defined by the shell 12 is accessible. The second face 26 is circumferentially larger than the first face 18. The first face 18 and the second face 26 may be circularly shaped, as shown in FIG. 2, or alternatively shaped, such as, but not limited to, squarely shaped, ovally shaped, and the like.

The shell 12 has a sidewall 30, which is resiliently deformable. The sidewall 30 comprises at least one of plastic, silicone, and rubber. The sidewall 30 comprises a plurality of interconnected sections 32 so that the shell 12 is selectively extendible from a compact configuration, as shown in FIG. 1, to a deployed configuration, as shown in FIG. 2. With the shell 12 in the deployed configuration, the sidewall 30 is configured to be gripped between digits of a hand of a user. The shell 12 thus facilitates gripping of the electronic device by the user.

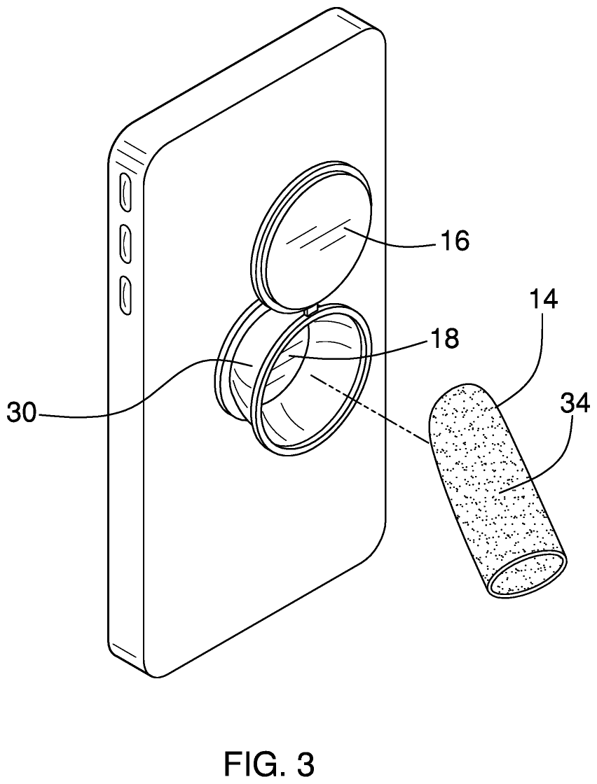

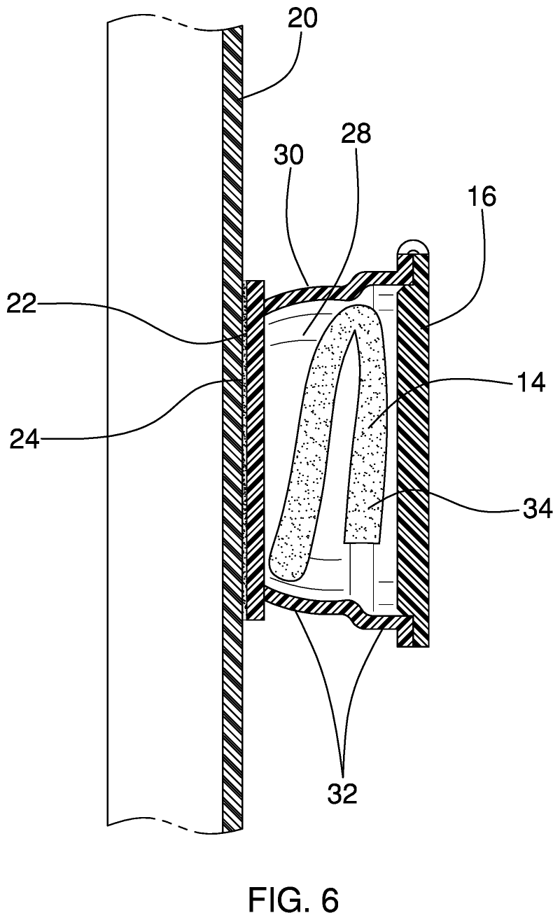

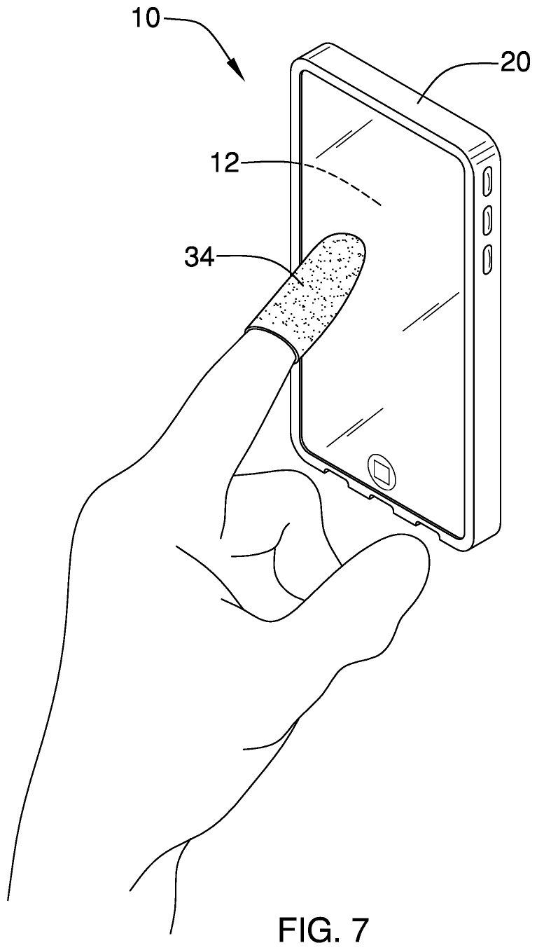

The cloth 14 is configured to clean a surface, such as a screen of the electronic device, and is selectively positionable in the interior space 28, as shown in FIG. 6. The cloth 14 may be configured as a sleeve 34, as shown in FIG. 3. The sleeve 34 is configured for insertion of a digit of a hand of the user, as shown in FIG. 7. The sleeve 34 is sized so that the sleeve 34 covers the digit to proximate to an interphalangeal joint of the digit. The cloth 14 may comprise microfiber fabric, or other type of cleaning material, such as, but not limited to, cotton fabric, nylon fabric, and the like.

The lid 16 is selectively engageable to the shell 12 to close the second face 26 to retain the cloth 14 in the shell 12. The lid 16 is configured to be disengaged from the shell 12 by the user, positioning the user to access the cloth 14 to clean the surface. The lid 16 may be hingedly engaged to the shell 12, as shown in FIG. 3. The present invention also anticipates the lid 16 being detachable from the shell 12.

The present invention anticipates the sidewall 30 being phosphorescent so that the sidewall 30 is configured to emit light. With the sidewall 30 being phosphorescent, the electronic device is locatable by the user in a dark environment. The present invention also anticipates the lid 16 being phosphorescent so that the lid 16 is configured to emit light. With the lid 16 being phosphorescent, the electronic device is locatable in the dark environment.

In use, the shell 12 is engaged to the case 20 using the adhesive 24. The shell 12 then is positioned to be extended from the case 20 to the deployed configuration to facilitate gripping of the electronic device. Should the screen of the electronic device require cleaning, the lid 16 can be hinged open so that the sleeve 34 is accessible. The digit of the user is inserted into the sleeve 34, and the sleeve 34 then can be used to clean the screen, as shown in FIG. 7.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A stowage module and cleaning cloth assembly comprising:
a shell configured to be mountable by a first face to at least one of an electronic device and a case engaged thereto, the shell having a second face, the second face being open such that an interior space defined by the shell is accessible;
a cloth configured for cleaning a surface and being selectively positionable in the interior space; and
a lid selectively engageable to the shell for closing the second face for retaining the cloth in the shell, wherein the lid is configured for being disengaged from the shell by a user, positioning the user for accessing the cloth for cleaning the surface.

2. The stowage module and cleaning cloth assembly of claim 1, wherein:
the second face is circumferentially larger than the first face; and
the shell has a sidewall, the sidewall being resiliently deformable, the sidewall comprising a plurality of interconnected sections such that the shell is selectively extendible from a compact configuration to a deployed configuration, wherein the sidewall is configured for gripping between digits of a hand of the user.

3. The stowage module and cleaning cloth assembly of claim 2, wherein the sidewall comprises at least one of plastic, silicone, and rubber, such that the sidewall is resiliently deformable.

4. The stowage module and cleaning cloth assembly of claim 1, wherein a sidewall of the shell is phosphorescent, wherein the sidewall is configured for emitting light such that the electronic device is locatable by the user in a dark environment.

5. The stowage module and cleaning cloth assembly of claim 1, wherein the first face and the second face are circularly shaped.

6. The stowage module and cleaning cloth assembly of claim 1, further including a fastener engaged to the first face and being configured for engaging at least one of the electronic device and the case engaged thereto.

7. The stowage module and cleaning cloth assembly of claim 6, wherein the fastener comprises adhesive.

8. The stowage module and cleaning cloth assembly of claim 1, wherein the cloth is configured as a sleeve, wherein the sleeve is configured for insertion of a digit of a hand of the user.

9. The stowage module and cleaning cloth assembly of claim 8, wherein the sleeve is sized such that the sleeve covers the digit to proximate to an interphalangeal joint of the digit.

10. The stowage module and cleaning cloth assembly of claim 1, wherein the cloth comprises microfiber fabric.

11. The stowage module and cleaning cloth assembly of claim 1, wherein the lid is hingedly engaged to the shell.

12. The stowage module and cleaning cloth assembly of claim 1, wherein the lid is phosphorescent, wherein the lid is configured for emitting light such that the electronic device is locatable by the user in a dark environment.

13. A case, stowage module, and cleaning cloth assembly comprising:
a case configured for insertion of an electronic device such that a screen of the electronic device is accessible to a user;
a shell mounted by a first face to the case, the shell having a second face, the second face being open such that an interior space defined by the shell is accessible;
a cloth configured for cleaning the screen of the electronic device and being selectively positionable in the interior space; and
a lid selectively engageable to the shell for closing the second face for retaining the cloth in the shell, wherein the lid is configured for being disengaged from the shell by a user, positioning the user for accessing the cloth for cleaning the screen.

14. The case, stowage module, and cleaning cloth assembly of claim 13, wherein:
the second face is circumferentially larger than the first face;
the first face and the second face are circularly shaped;
the shell has a sidewall, the sidewall comprises at least one of plastic, silicone, and rubber such that the sidewall is resiliently deformable;
the sidewall comprises a plurality of interconnected sections such that the shell is selectively extendible from a compact configuration to a deployed configuration, wherein the sidewall is configured for gripping between digits of a hand of the user; and
the sidewall is phosphorescent, wherein the sidewall is configured for emitting light such that the electronic device is locatable by the user in a dark environment.

15. The case, stowage module, and cleaning cloth assembly of claim 13, further including a fastener engaged to the first face and being configured for engaging at least one of the electronic device and the case engaged thereto, the fastener comprising adhesive.

16. The case, stowage module, and cleaning cloth assembly of claim 13, wherein the cloth is configured as a sleeve, wherein the sleeve is configured for insertion of a digit of a hand of the user, the sleeve being sized such that the sleeve covers the digit to proximate to an interphalangeal joint of the digit.

17. The case, stowage module, and cleaning cloth assembly of claim 13, wherein the cloth comprises microfiber fabric.

18. The case, stowage module, and cleaning cloth assembly of claim 13, wherein the lid is hingedly engaged to the shell.

19. The case, stowage module, and cleaning cloth assembly of claim 13, wherein the lid is phosphorescent, wherein the lid is configured for emitting light such that the electronic device is locatable by the user in a dark environment.

20. A stowage module and cleaning cloth assembly comprising:
a shell configured to be mountable by a first face to at least one of an electronic device and a case engaged thereto, the shell having a second face, the second face being open such that an interior space defined by the shell is accessible, the second face being circumferentially larger than the first face, the shell having a sidewall, the sidewall being resiliently deformable, the sidewall comprising a plurality of interconnected sections such that the shell is selectively extendible from a compact configuration to a deployed configuration, wherein the sidewall is configured for gripping between digits of a hand of a user, the sidewall comprising at least one of plastic, silicone, and rubber such that the sidewall is resiliently deformable, the sidewall being phosphorescent wherein the sidewall is configured for emitting light such that the electronic device is locatable by the user in a dark environment, the first face and the second face being circularly shaped;
a fastener engaged to the first face and being configured for engaging at least one of the electronic device and the case engaged thereto, the fastener comprising adhesive;
a cloth configured for cleaning a surface and being selectively positionable in the interior space, the cloth being configured as a sleeve wherein the sleeve is configured for insertion of a digit of the user, the sleeve being sized such that the sleeve covers the digit to proximate to an interphalangeal joint of the digit, the cloth comprising microfiber fabric; and
a lid selectively engageable to the shell for closing the second face for retaining the cloth in the shell, wherein the lid is configured for being disengaged from the shell by the user, positioning the user for accessing the cloth for cleaning the surface, the lid being hingedly engaged to the shell, the lid being phosphorescent wherein the lid is configured for emitting light such that the electronic device is locatable in the dark environment.
